(19) United States
(12) Patent Application Publication
(10) Pub. No.: US 2014/0272317 A1
(43) Pub. Date: Sep. 18, 2014

(54) ADHESIVE JOINT FOR JOINING PANELS

(71) Applicant: GM GLOBAL TECHNOLOGY OPERATIONS LLC, Detroit, MI (US)

(72) Inventors: Joseph M. Polewarczyk, Rochester Hills, MI (US); Hesham A. Ezzat, Troy, MI (US)

(73) Assignee: GM GLOBAL TECHNOLOGY OPERATIONS LLC, Detroit, MI (US)

(21) Appl. No.: 13/826,290

(22) Filed: Mar. 14, 2013

(51) Int. Cl. B32B 7/12; B32B 3/28; B32B 37/12

(52) U.S. Cl. CPC B32B 7/12; B32B 37/1284; B32B 3/28
USPC 428/174; 156/293

(57) ABSTRACT

A first panel defines a first surface characterized by a first base portion and a protuberance extending from the first base portion. A second panel defines a second surface having a second base portion and a depression. The protuberance extends into the depression, and adhesive is disposed on the first base portion, the protuberance, the second base portion, and in the depression, to bond the first panel to the second panel. The protuberance and surface defining the depression provide regions of shear when the base portions are in peel, thereby increasing the strength of the adhesive joint between the first and second panels.

### TECHNICAL FIELD

This invention relates to adhesive joints connecting panels.

### BACKGROUND

Automotive body panels are typically formed of metals, and are joined together by welding. Some body panels are formed of non-metallic composite materials, such as fiberglass, and therefore cannot be welded. Composite panels are typically joined together with adhesive applied to mating flanges.

### SUMMARY

A first panel defines a first surface characterized by a first base portion and a protuberance extending from the first base portion. A second panel defines a second surface having a second base portion and a depression. The protuberance extends into the depression, and adhesive is disposed on the first base portion, the protuberance, the second base portion, and in the depression, to bond the first panel to the second panel. The protuberance and surface defining the depression provide regions of shear when the base portions are in peel, thereby increasing the strength of the adhesive joint between the first and second panels.

A corresponding method of joining two panels is also provided.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, perspective view of a first panel and a second panel prior to being joined;

FIG. 2 is a schematic, perspective view of a protuberance formed on a surface of the first panel;

FIG. 3 is a schematic, top view of the protuberance of FIG. 2;

FIG. 4 is a schematic, perspective view of a depression formed in a surface of the second panel;

FIG. 5 is a schematic, cross-sectional side view of the first and second panels joined together with adhesive such that the protuberance of FIGS. 2 and 3 is disposed within the depression of FIG. 4; and

FIG. 6 is a schematic, cross-sectional side view of an alternative embodiment of panels joined together with adhesive in accordance with the claimed invention.

### DETAILED DESCRIPTION

Referring to FIG. 1, a first flange 10 and a second flange 14 are schematically depicted. The first flange 10 is part of a first panel 18, and the second flange 14 is part of a second panel 22. The first and second panels 18, 22 in the embodiment depicted comprise a composite material, and may, for example, be vehicle body panels such as the inner and outer panels of a vehicle door, fender, hood, rear decklid, etc. However, it should be noted that the panels 18, 22 may comprise any material and may be used for any purpose within the scope of the claimed invention.

The first flange 10 of the first panel 18 defines a first surface 26 characterized by a first base portion 30. The first base portion 30 in the embodiment depicted is substantially planar. The first surface 26 also defines a plurality of protuberances 34 extending from the first base portion 30. The second flange 14 of the second panel 22 defines a second surface 38 facing the first surface 26.

Referring to FIGS. 2 and 3, wherein like reference numbers refer to like components from FIG. 1, one of the protuberances 34 is schematically depicted. The protuberance 34 shown in FIGS. 2 and 3 is representative of all of the protuberances 34 shown in FIG. 1. The protuberance 34 is frusto-pyramidal in shape, i.e., the protuberance 34 has the shape or appearance of a pyramid cut by a plane that is parallel to the pyramid's base. Thus, each protuberance 34 includes four planar surface portions 42, 44, 46, 48 that extend from the base portion 30 to the terminal end 50 of the protuberance 34. The terminal end 50 is a square, planar surface portion 52 that is parallel to the base portion 30 of the first surface 26.

Referring to FIG. 4, wherein like reference numbers refer to like components from FIGS. 1-3, the second surface 38 has a planar second base portion 54 and a plurality of depressions 58, only one of which is shown in FIG. 4. The depression 58 shown in FIG. 4 is representative of all the depressions 58 in the second flange 14. The depression 58 is frusto-pyramidal in shape. More specifically, the depression 58 is formed by four planar surface portions 60, 62, 64, 66 that extend from the second base portion 54 to a square, planar surface portion 68 that forms the terminal end of the depression 58. The square, planar surface portion 68 is parallel to the second base portion 54.

The second flange 14 defines a third surface 72 that is on the opposite side of the second flange 14 from the second surface 38. In the embodiment depicted, the depth of the depressions 58 is greater than the thickness of the flange 14, and thus there is a frusto-pyramidal protuberance (shown at 74 in FIG. 1) on the third surface 72 for each depression 58 on the second surface 38.

Referring to FIG. 5, wherein like reference numbers refer to like components from FIGS. 1-4, an adhesive joint 75 bonding the first and second flanges 10, 14 is formed by applying an adhesive 76 to one of the first surface 26 and the second surface 38, and then positioning the first panel 18 with respect to the second panel 22 such that each of the protuberances 34 extends into a respective one of the depressions 58, as shown in FIG. 5. When the flanges 10, 14 are brought together, the adhesive 76 is disposed on the first surface 26 (including the first base portion 30 and the all surface portions 42, 44, 46, 48, 52 of the protuberances 34) and the second surface 38 (including the second base portion 54 and all surface portions 60, 62, 64, 66, 68 defining the depressions 58), thereby bonding the first panel 18 and the second panel 22 together. The first base portion 30 faces, and is parallel to, the second base portion 54; adhesive 76 extends therebetween, bonding the base portions 30, 54 together.

For each protuberance 34, each of the surface portions 42, 44, 46, 48, 52 is parallel with, and directly bonded via the adhesive 76 to, a corresponding surface portion 60, 62, 64, 66, 68 defining one of the depressions 58. More specifically, as shown in FIG. 5, each surface portion 42 faces, and is parallel to, a respective surface portion 60; adhesive 76 extends therebetween, directly bonding portion 42 to portion 60. Each surface portion 46 faces, and is parallel to, a respective surface portion 64; adhesive 76 extends therebetween, directly bonding portion 46 to portion 64. Each surface portion 52 faces, and is parallel to, a respective surface portion 68; adhesive 76 extends therebetween, directly bonding portion 52 to portion 68. Although not shown in FIG. 5, each surface portion 44 faces, and is parallel to, a respective surface portion 62; adhesive 76 extends therebetween, directly bonding portion 44 to portion 62. Similarly, each surface portion 48 faces, and is parallel to, a respective surface portion 66; adhesive 76 extends therebetween, directly bonding portion 44 to portion 66.

Surface portions 42, 44, 46, 48, 52 are all in different planes from each other and from the first base portion 30, and none of surface portions 42, 44, 46, 48 are parallel to each other or to the base portion 30. Similarly, surface portions 60, 62, 64, 66, 68 are all in different planes from each other and from the second base portion 54, and none of surface portions 60, 62, 64, 66 are parallel to each other or to the base portion 54.

Accordingly, the protuberances 34 and the depressions 58 add several surface portions in differing planes that have adhesive 76 thereon, and thus add some shear loaded adhesive in directions that might normally be purely in peel when a stress is applied to the panels 18, 22. Adhesive 76 may be significantly stronger in shear than in peel, and thus the protuberances 34 and depressions 58 strengthen the bond between the first and second panels 18, 22 by creating regions of shear stress that would otherwise be in peel. When the adhesive 76 between the base portions 30, 54 is in peel, adhesive 76 between the protuberances 34 and the depressions 58 may be in shear. Thus, the adhesive joint 75 may eliminate a need for mechanical fasteners (such as nuts and bolts) to resist peel forces. The protuberances 34 and the depressions 58 also provide a mechanical interlock between the flanges 10, 14 along the plane of the joint 75.

Referring again to FIG. 2, surface portion 42 forms an angle 78 with the base portion 30. In the embodiment depicted, angle 78 is approximately 135 degrees. The angle 78 is between 90 and 135 degrees to increase the shear between the protuberance 34 and the depression 58 when the base portions 30, 54 are in peel. Surface portions 44, 46, 48 also form angles with the base portion 30 that are between 90 and 135 degrees.

Referring to FIG. 6, a first flange 110 and a second flange 114 are schematically depicted. The first flange 110 is part of a first panel 118, and the second flange 114 is part of a second panel 122. The first and second panels 118, 122 in the embodiment depicted comprise a composite material, and may, for example, be vehicle body panels such as the inner and outer panels of a vehicle door, fender, hood, rear decklid, etc. However, it should be noted that the panels 118, 122 may comprise any material and may be used for any purpose within the scope of the claimed invention.

The first flange 110 of the first panel 118 defines a first surface 126 characterized by a first base portion 130. The first base portion 130 in the embodiment depicted is substantially planar. The second flange 114 of the second panel 122 defines a second surface 134 facing the first surface 126. The second surface 134 is characterized by a second base portion 136, which is substantially planar.

The first surface 126 also defines a plurality of protuberances 138 extending from the first base portion 130. The protuberances 138 are spherical caps, i.e., the protuberances form spheres that are cut by a plane. In the embodiment depicted, the protuberances 138 are hemispheres. The second surface 134 also includes surface portions 140 that define a plurality of depressions 142, which, in the embodiment of FIG. 6, are hemispherical caps.

An adhesive joint 174 bonding the first and second flanges 110, 114 is formed by applying an adhesive 176 to one of the first surface 126 and the second surface 134, and then positioning the first panel 118 with respect to the second panel 122 such that each of the protuberances 138 extends into a respective one of the depressions 142, as shown in FIG. 6. When the flanges 110, 114 are brought together, the adhesive 176 is disposed on the first surface 126 (including the first base portion 130 and the all surface portions forming the protuberances 138) and the second surface 134 (including the second base portion 136 and all surface portions 140 defining the depressions 142), thereby bonding the first panel 118 and the second panel 122 together. The first base portion 130 faces, and is parallel to, the second base portion 136; adhesive 176 extends therebetween, bonding the base portions 130, 136 together.

The surface of each protuberance 138 is parallel with a respective surface portion 140 defining a respective depression 142; adhesive 176 also extends therebetween to bond the protuberances 138 to the surface portions 140. Accordingly, the protuberances 138 and the depressions 142 add several surface portions in differing planes that have adhesive 176 thereon, and thus add some shear loaded adhesive in directions that might normally be purely in peel when a stress is applied to the panels 118, 122.

It should be noted that the fit between protuberances 34 and depressions 58, and the fit between protuberances 138 and depressions 142, are clearance fits, rather than interference fits. In the embodiments depicted, the protuberances and depressions are shown as either frustums of pyramids or spherical caps; however, protuberances and depressions may have other shapes within the scope of the claimed invention. It should also be noted that, as used in the claims, a “depression” may include a hole that extends through a panel from one side to the other. In one embodiment (not shown), and within the scope of the claimed invention, the depressions are cylindrical holes and the protuberances are cylindrical knobs.

While the best modes for carrying out the invention have been described in detail, those familiar with the art to which this invention relates will recognize various alternative designs and embodiments for practicing the invention within the scope of the appended claims.

1. An apparatus comprising:
a first panel defining a first surface characterized by a first base portion and a protuberance extending from the first base portion;
a second panel defining a second surface having a second base portion and a depression;
an adhesive;
wherein the protuberance extends into the depression; and
wherein the adhesive is disposed on the first base portion, the protuberance, the second base portion, and in the depression, to bond the first panel to the second panel.

2. The apparatus of claim 1, wherein the first panel and the second panel comprise at least one composite material.

3. The apparatus of claim 1, wherein the protuberance includes a surface that forms an angle with the first base portion that is between ninety and one hundred and thirty-five degrees.

4. The apparatus of claim 1, wherein the protuberance and the depression are frusto-pyramidal.

5. The apparatus of claim 1, wherein the protuberance and the depression are spherical caps.

6. The apparatus of claim 1, wherein the fit between the protuberance and the depression is a clearance fit.

7. An apparatus comprising:
a first panel defining a first surface characterized by a first base portion and a plurality of protuberances extending from the first base portion;
a second panel defining a second surface having a second base portion and a plurality of depressions;
an adhesive;
wherein each of the protuberances extends into a respective one of the depressions; and
wherein the adhesive is disposed on the first base portion, the protuberances, the second base portion, and in the depressions, to bond the first panel to the second panel.

8. The apparatus of claim 7, wherein the first panel and the second panel comprise at least one composite material.

9. The apparatus of claim 7, wherein the each of the protuberances includes a respective surface that forms an angle with the first surface that is between ninety and one hundred and thirty-five degrees.

10. The apparatus of claim 7, wherein the protuberances and the depressions are frusto-pyramidal.

11. The apparatus of claim 7, wherein the protuberances and the depressions are spherical caps.

12. The apparatus of claim 7, wherein the fit between the protuberances and the depressions is a clearance fit.

13. A method of joining panels, comprising:
providing a first panel defining a first surface characterized by a first base portion and a plurality of protuberances extending from the first base portion;
providing a second panel defining a second surface having a second base portion and a plurality of depressions;
applying an adhesive to one of the first surface and the second surface; and
positioning the first panel with respect to the second panel such that each of the protuberances extends into a respective one of the depressions.

14. The method of claim 13, wherein the first panel and the second panel comprise at least one composite material.

15. The method of claim 13, wherein the each of the protuberances includes a respective surface that forms an angle with the first surface that is between ninety and one hundred and thirty-five degrees.

16. The method of claim 13, wherein the protuberances and the depressions are frusto-pyramidal.

17. The method of claim 13, wherein the protuberances and the depressions are spherical caps.

18. The method of claim 13, wherein the fit between the protuberances and the depressions is a clearance fit.
